(19) United States
(12) Patent Application Publication
(10) Pub. No.: US 2021/0388154 A1
(43) Pub. Date: Dec. 16, 2021

(54) Polyglycolic Acid Copolymer Composition and Preparation Thereof

(71) Applicant: Pujing Chemical Industry Co., Ltd., Shanghai (CN)

(72) Inventor: Xinzhou ZHANG, Shanghai (CN)

(21) Appl. No.: 17/289,410

(22) PCT Filed: Oct. 29, 2018
(86) PCT No.: PCT/CN2018/112466

§ 371 Date: Apr. 28, 2021

(51) Int. Cl. C08G 63/06; C08K 7/02; C08K 3/04; C08K 3/40; C08G 63/08; C08K 7/14; C08K 7/04

(52) U.S. Cl. CPC C08G 63/06; C08K 7/02; C08K 3/04; C08K 7/04; C08G 63/08; C08K 7/14; C08K 3/40

(57) ABSTRACT

The invention relates to a novel composition comprising a polyglycolic acid or a polyglycolic acid copolymer and a filler. The polyglycolic acid is prepared made from methyl glycolate by polycondensation. The composition may have a tensile modulus greater than 5,800 MPa. The polyglycolic acid copolymer may have a weight-average molecular weight (Mw) in the range of 10,000-1,000,000 and a ratio of a weight-average molecular weight to a number-average molecular weight (Mw/Mn) in the range of 1.0 to 10.0. The polyglycolic acid copolymer may have a melt index (MFR) in the range of 0.1 to 1000 g/10 min. Also provided is a process for preparing the composition involving direct polymerization of methyl glycolate.

### FIELD OF THE INVENTION

The invention provides a novel polyglycolic acid copolymer composition having high stiffness, and preparation thereof. The composition has good melting thermal stability and has a high tensile modulus both at room temperature and high temperature.

### BACKGROUND OF THE INVENTION

As an environmentally friendly polymer material, polyglycolic acid, also known as poly (glycolic acid) (PGA), is biodegradable and has attracted a lot of attention in recent years. Compared to other biodegradable plastics such as polylactic acid, polyglycolic acid has great advantages in tensile strength, flexural strength, flexural modulus, hardness, flexibility, heat resistance, etc. Unlike polylactic acid, polyglycolic acid has a high gas barrier, which is ideal for use in fibers, downhole tools, packaging, films, pharmaceutical carriers, medical implantable devices, underwater antifouling materials, and more.

However, the tensile modulus of traditional polyglycolic acid dropped dramatically at high temperatures (CN1827686B), which limits the use of polyglycolic acid in high temperature environments. A blend of polyglycolic acid and an inorganic filler has been reported (CN104684997B), but the addition of such inorganic filler also caused degradation of the polyglycolic acid, thereby reducing its thermal stability and mechanical properties.

There remains a need for polyglycolic acid or polyglycolic acid copolymers having good melting thermal stability and high tensile modulus.

### SUMMARY OF THE INVENTION

The present invention provides a composition comprising a polyglycolic acid or a polyglycolic acid copolymer and preparation thereof.

A composition is provided. The composition comprises 20-99.9 wt % of a polyglycolic acid or a polyglycolic acid copolymer and 0.1-80 wt % of a filler, based on the total weight of the composition. The polyglycolic acid is prepared from methyl glycolate by polycondensation. The composition has a tensile modulus greater than 5,800 MPa. The polyglycolic acid copolymer comprises one or more repeating units of C-(Aₓ-B_{y})ₙ-D, wherein
A is

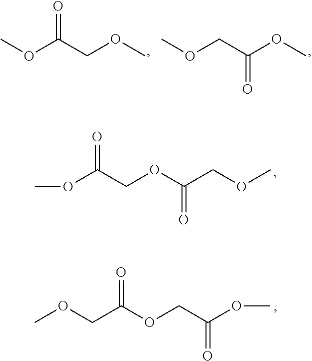

or a combination thereof;
B is G-R₁—W; G and W are each selected from the group consisting of —CO—NH—, —CO—R₂—CO—OH, —CO—, —(CH₂)₂NH—CO—, —CH₂—CH(OH)—CH₂— and —NH; R₁ is an aliphatic polymer, an aromatic polymer or a combination thereof; R₂ is an alkyl group, an aromatic group, or an olefin group; x is between 1 and 1500; y is between 1 and 1500; n is between 1 and 10000; C and D are each a terminal group selected from the group consisting of a hydroxyl group, a carboxyl group, an amine group, an alkyl group, an aromatic group, an ether group, an alkene group, a halogenated hydrocarbon group and a combination thereof; and A and B are different in structure.

The filler may be an inorganic filler selected from the group consisting of glass fiber, glass beads, talc, calcium carbonate, nano-clay, hydrotalcite, carbon black, carbon fiber, carbon nanotube, graphene, titanium dioxide, silicon dioxide, montmorillon Soil, steel fiber, hemp fiber, bamboo fiber, wood fiber, wood powder, wood chip, alumina, magnesia, zinc oxide, aluminum nitride, boron nitride, silicon carbide, graphite, silicon carbide, potassium titanate, aluminum borate, calcium sulfate, magnesium sulfate, ceramic whiskers, inorganic salt whiskers, metal whiskers and a combination thereof.

The filler may be an organic filler is selected from the group consisting of cellulose whisker, poly(butyl acrylate-styrene), poly(4-hydroxybenzyl ester), polyethylene fiber, polyester fiber, aramid fiber, poly(p-phenylene benzobisoxazole)(PBO) fiber, polyamide fiber and a combination thereof.

The composition may further comprise one or more of units of i-R₁-j; i and j are each selected from the group consisting of an isocyanate group (—N═C═O), an acid chloride group, an oxazolyl group, an oxazoline group, an anhydride, an epoxy group, an amine group and a combination thereof; R₁ is an aliphatic group, an aromatic group, or a combination thereof.

The composition may further comprise an agent selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

The polyglycolic acid or the polyglycolic acid copolymer may have a weight-average molecular weight of 10,000-1,000,000. The polyglycolic acid or the polyglycolic acid copolymer may have a ratio of a weight-average molecular weight to a number-average molecular weight (Mw/Mn) at 10-4.0.

The polyglycolic acid in the composition may be prepared by direct polymerizing methyl glycolate.

The polyglycolic acid copolymer in the composition may be prepared according to a process comprising (a) direct polymerizing methyl glycolate, whereby a polyglycolic acid is formed; and (b) extruding the polyglycolic acid, E and F into particles. The composition comprises a combination of the E and the F at 0.01-5 wt % based on the total weight of the copolymer. E may be one or more of units of i-R₁-j; i and j are each selected from the group consisting of an isocyanate group (—N═C═O), an acid chloride group, an oxazolyl group, an oxazoline group, an anhydride, an epoxy group, an amine group and a combination thereof; R₁ is an aliphatic group, an aromatic group, or a combination thereof. F may be selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

The polyglycolic acid copolymer in the composition may be prepared by a process comprising extruding the polyglycolic acid copolymer and the filler into particles. The particles may comprise 0.1-80 wt % of the filler based on the total weight of the particles.

The polyglycolic acid or the polyglycolic acid copolymer in the composition may have a melt flow rate (MFR) of 0.1-1000 g/10 min.

For each composition of the invention, a process for preparing the composition is provided. The composition comprises 20-99.9 wt % of a polyglycolic acid copolymer and 0.1-80 wt % of a filler, based on the total weight of the composition. The polyglycolic acid copolymer is prepared with a polyglycolic acid produced from methyl glycolate by polycondensation. The composition has a tensile modulus greater than 5,800 MPa. The process comprises extruding and granulating a polyglycolic acid copolymer with a filler. The polyglycolic acid copolymer comprises one or more repeating units of C-(Aₓ-B_{y})ₙ-D. A is

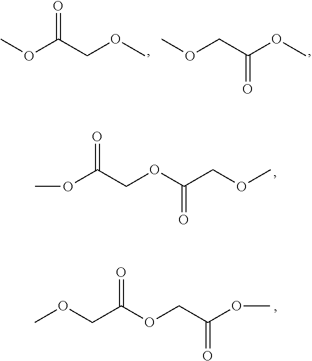

or a combination thereof; B is G-R₁—W; G and W are each selected from the group consisting of —CO—NH—, —CO—R₂—CO—OH, —CO—, —(CH₂)₂NH—CO—, —CH₂—CH(OH)—CH₂— and —NH; R₁ is an aliphatic polymer, an aromatic polymer or a combination thereof; R₂ is an alkyl group, an aromatic group, or an olefin group; x is between 1 and 1500; y is between 1 and 1500; n is between 1 and 10000; C and D are each a terminal group selected from the group consisting of a hydroxyl group, a carboxyl group, an amine group, an alkyl group, an aromatic group, an ether group, an alkene group, a halogenated hydrocarbon group and a combination thereof; and A and B are different in structure. As a result, the composition is prepared.

According to the process of the invention, the filler may be an inorganic filler selected from the group consisting of glass fiber, glass beads, talc, calcium carbonate, nano-clay, hydrotalcite, carbon black, carbon fiber, carbon nanotube, graphene, titanium dioxide, silicon dioxide, montmorillon Soil, steel fiber, hemp fiber, bamboo fiber, wood fiber, wood powder, wood chip, alumina, magnesia, zinc oxide, aluminum nitride, boron nitride, silicon carbide, graphite, silicon carbide, potassium titanate, aluminum borate, calcium sulfate, magnesium sulfate, ceramic whiskers, inorganic salt whiskers, metal whiskers and a combination thereof. The filler may be an organic filler is selected from the group consisting of cellulose whisker, poly(butyl acrylate-styrene), poly(4-hydroxybenzyl ester), polyethylene fiber, polyester fiber, aramid fiber, poly(p-phenylene benzobisoxazole)(PBO) fiber, polyamide fiber and a combination thereof.

The process may further comprise extruding and granulating the polyglycolic acid before extrusion and granulation of the polyglycolic acid with the filler.

The process may further comprise comprising extruding and granulating the polyglycolic acid with an additive before extrusion and granulation of the polyglycolic acid with the filler;

The additive may be selected from the group consisting of E, F or a combination thereof. E may be one or more of units of i-R₁-j; i and j are each selected from the group consisting of an isocyanate group (—N═C═O), an acid chloride group, an oxazolyl group, an oxazoline group, an anhydride, an epoxy group, an amine group and a combination thereof; R₁ is an aliphatic group, an aromatic group, or a combination thereof. F may be selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

The process may further comprise ring-opening polymerizing glycolide in a molten state to form the polyglycolic acid.

A composition prepared according to the process of the invention.

For each composition of the invention, a process for preparing the composition is provided. The composition comprises 20-99.9 wt % of a polyglycolic acid copolymer and 0.1-80 wt % of a filler, based on the total weight of the composition. The polyglycolic acid copolymer is prepared with a polyglycolic acid produced from methyl glycolate by polycondensation. The composition has a tensile modulus greater than 5,800 MPa. The process comprises extruding and granulating a polyglycolic acid copolymer with a filler. The polyglycolic acid copolymer comprises one or more repeating units of C-(Aₓ-B_{y})ₙ-D. A is

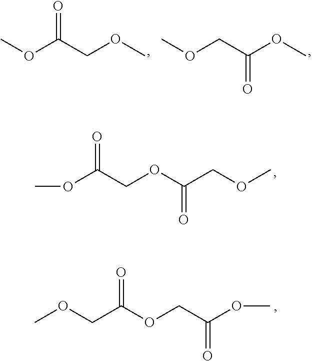

or a combination thereof; [?First three structures look the same?]B is G-R₁-W; G and W are each selected from the group consisting of —CO—NH—, —CO—R₂—CO—OH, —CO—, —(CH₂)₂NH—CO—, —CH₂—CH(OH)-CH₂— and —NH; R₁ is an aliphatic polymer, an aromatic polymer or a combination thereof; R₂ is an alkyl group, an aromatic group, or an olefin group; x is between 1 and 1500; y is between 1 and 1500; n is between 1 and 10000; C and D are each a terminal group selected from the group consisting of a hydroxyl group, a carboxyl group, an amine group, an alkyl group, an aromatic group, an ether group, an alkene group, a halogenated hydrocarbon group and a combination thereof; and A and B are different in structure. As a result, the composition is prepared.

According to the process of the invention, the filler may be an inorganic filler selected from the group consisting of glass fiber, glass beads, talc, calcium carbonate, nano-clay, hydrotalcite, carbon black, carbon fiber, carbon nanotube, graphene, titanium dioxide, silicon dioxide, montmorillon Soil, steel fiber, hemp fiber, bamboo fiber, wood fiber, wood powder, wood chip, alumina, magnesia, zinc oxide, aluminum nitride, boron nitride, silicon carbide, graphite, silicon carbide, potassium titanate, aluminum borate, calcium sulfate, magnesium sulfate, ceramic whiskers, inorganic salt whiskers, metal whiskers and a combination thereof. The filler may be an organic filler is selected from the group consisting of cellulose whisker, poly(butyl acrylate-styrene), poly(4-hydroxybenzyl ester), polyethylene fiber, polyester fiber, aramid fiber, poly(p-phenylene benzobisoxazole)(PBO) fiber, polyamide fiber and a combination thereof.

The process may further comprise extruding and granulating the polyglycolic acid before extrusion and granulation of the polyglycolic acid with the filler.

The process may further comprise comprising extruding and granulating the polyglycolic acid with an additive before extrusion and granulation of the polyglycolic acid with the filler;

The additive may be selected from the group consisting of E, F or a combination thereof. E may be one or more of units of i-R₁-j; i and j are each selected from the group consisting of an isocyanate group (—N═C═O), an acid chloride group, an oxazolyl group, an oxazoline group, an anhydride, an epoxy group, an amine group and a combination thereof; R₁ is an aliphatic group, an aromatic group, or a combination thereof. F may be selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

The process may further comprise ring-opening polymerizing glycolide in a molten state to form the polyglycolic acid.

A composition prepared according to the process of the invention.

### DETAILED DESCRIPTION OF THE INVENTION

The invention provides novel rigid polyglycolic acid or polyglycolic acid copolymer compositions and preparation thereof. The inventors have surprisingly discovered that, despite polyglycolic acid degradation in production of polyglycolic acid compositions by extrusion, the addition of a filler such as talc, glass fiber, carbon fiber and aramid fiber to a polyglycolic acid or polyglycolic acid copolymer in making a polyglycolic acid or polyglycolic acid copolymer compositions by extrusion improved the polymer's melting thermal stability and/or the tensile modulus at room temperature and high temperature. The preparation process eliminates the synthesis of polyglycolic acid from methyl glycolate, thereby avoiding the impurities formed in the process and the residues from the use of a catalyst. Thus, the resulting product has less impurities, better thermal stability, and excellent melting thermal stability. Moreover, the polyglycolic acid copolymer made of a polyglycolic acid maintains the excellent melting thermal stability when combined with metal passivating agents and fillers in compositions. With improved thermal stability, hydrolytic stability, and mechanical properties, the polyglycolic acid or polyglycolic acid copolymer compositions of the present invention are suitable for diverse uses, for example, fibers, downhole tools, packaging, film, drug carriers, abrasives, medical implants, and underwater antifouling materials, etc.

The terms “polyglycolide,” “poly (glycolic acid) (PGA)” and “polyglycolic acid” are used herein interchangeably and refer to a biodegradable, thermoplastic polymer composed of monomer glycolic acid. A polyglycolic acid may be prepared from glycolic acid by polycondensation or glycolide by ring-opening polymerization. An additive may be added to the polyglycolic acid to achieve a desirable property.

The term “polyglycolic acid copolymer” is a polymer derived from a glycolide or glycolic acid monomer and a different polymer monomer. For example, a polyglycolic acid copolymer may be prepared with a polyglycolic acid and ADR4368 (a commercial epoxy polymer of styrene and acrylic acid from BASF) by extrusion.

The term “filler” used herein refers to a compound that fills in a space in a composition comprising a polyglycolic acid or a polyglycolic acid copolymer.

A composition is provided. The composition comprises (a) a polyglycolic acid or a polyglycolic acid copolymer and (b) an inorganic or organic filler. The polyglycolic acid is prepared from methyl glycolate by polycondensation. The composition may have a tensile modulus greater than about 5,000, 5,500, 5,600, 5,700, 5,800, 5,900 or 6,000 MPa.

The composition may comprise about 20-99.9 wt %, 20-99 wt %, 30-95 wt %, 40-90 wt %, 50-80 wt % or 60-70 wt % of the polyglycolic acid or the polyglycolic acid copolymer, based on the total weight of the composition.

The composition may comprise about 0.1-80 wt %, 1-70 wt %, 5-60 wt %, 10-50 wt % or 20-40 wt % of the filler, based on the total weight of the composition. The filler may be an inorganic substance. The filler may be an organic substance. The inorganic filler may be selected from the group consisting of glass fiber, glass beads, talc, calcium carbonate, nano-clay, hydrotalcite, carbon black, carbon fiber, carbon nanotube, graphene, titanium dioxide, silicon dioxide, montmorillon Soil, steel fiber, hemp fiber, bamboo fiber, wood fiber, wood powder, wood chip, alumina, magnesia, zinc oxide, aluminum nitride, boron nitride, silicon carbide, graphite, silicon carbide, potassium titanate, aluminum borate, calcium sulfate, magnesium sulfate, ceramic whiskers, inorganic salt whiskers, metal whiskers and a combination thereof. The organic filler may be selected from the group consisting of cellulose whisker, poly(butyl acrylate-styrene), poly(4-hydroxybenzyl ester), polyethylene fiber, polyester fiber, aramid fiber, One or more of poly(p-phenylene benzobisoxazole)(PBO) fiber, polyamide fiber and a combination thereof.

The composition may further comprise one or more of units of i-R₁-j. i and j are each selected from the group consisting of an isocyanate group (—N═C═O), an acid chloride group, an oxazolyl group, an oxazoline group, an anhydride, an epoxy group, an amine group and a combination thereof. R₁ may be an aliphatic group, an aromatic group, or a combination thereof.

The composition may further comprise an agent selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

The polyglycolic acid copolymer may comprise one or more repeating units of C-(Aₓ-B_{y})ₙ-D. A is selected from the group consisting of

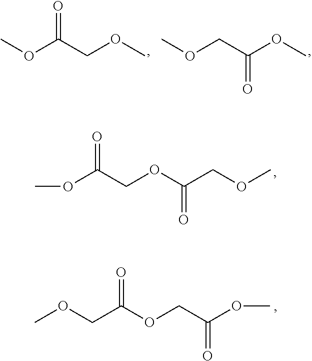

and a combination thereof. B is G-R₁—W, in which G and W are each selected from the group consisting of —CO—NH—, —CO—R₂—CO—OH, —CO—, —(CH₂)₂NH—CO—, —CH₂—CH(OH)—CH₂— and —NH; R₁ is an aliphatic polymer, an aromatic polymer or a combination thereof; and R₂ is an alkyl group, an aromatic group, or an olefin group. x is between 1 and 1500. y is between 1 and 1500. n is between 1 and 10000. C and D are each a terminal group selected from the group consisting of a hydroxyl group, a carboxyl group, an amine group, an alkyl group, an aromatic group, an ether group, an alkene group, a halogenated hydrocarbon group and a combination thereof. A and B are different in structure.

The copolymer may further comprise E. E may be one or more of units of i-R₁-j. i and j are each selected from the group consisting of an isocyanate group (—N═C═O), an acid chloride group, an oxazolyl group, an oxazoline group, an anhydride, an epoxy group, an amine group and a combination thereof. R₁ may be an aliphatic group, an aromatic group, or a combination thereof.

The copolymer may further comprise F. F may be selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

An antioxidant may be selected from the group consisting of BASF Irganox 168, 101, 245, 1024, 1076, 1098, 3114, MD 1024, 1025 , ADEKA AO-60, 80, STAB PEP-36, 8T, Albemarle AT-10, 245, 330, 626, 702, 733, 816, 1135 a combination thereof.

A metal passivator may be selected from the group consisting of BASF Chel-180, Eastman OABH, Naugard XL-1, MD24, ADEKA STAB CDA-1, 6, oxalic acid derivatives, hydrazines, salicylic acid derivatives, benzotriazole and guanidine compounds, and a combination thereof.

The polyglycolic acid in the composition may be prepared by direct polymerization of methyl glycolate. For example, methyl glycolate may react with an esterification catalyst at an esterification reactor at 120-200° C. for 0.5-4 h. The esterification catalyst may be in an amount about 0-0.01 parts of the weight of the methyl glycolate. The materials in the esterification reactor may then be transferred into a polycondensation reactor for polycondensation. A polycondensation catalyst may be added into the reactor to catalyze the reaction. The polycondensation catalyst may be a rare earth catalyst. The polycondensation catalyst may be in an amount of 10⁻⁷ to 10⁻⁴ parts relative to the weight of the methyl glycolate. The polycondensation reaction may be carried out under an absolute pressure not greater than about 1000 Pa and at about 190-240° C. for about 2-10 h. The materials in the polycondensation reactor may be transferred into a devolatilization reactor for reaction under an absolute pressure of not greater than 1000 Pa and at about 200-250° C. for 10 min to 2 h.

The esterification catalyst may comprise a tin salt, a zinc salt, a titanium salt, a sulfonium salt, a tin oxide, a zinc oxide, a titanium oxide, a sulfonium oxide, or a combination thereof.

The polycondensation catalyst may comprise an oxide, compound or complex of a rare earth element or a combination thereof. The rare earth element may be selected from the group consisting of cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y).

The polyglycolic acid in the composition may be prepared by a process comprising direct polymerization of methyl glycolate to make a polyglycolic acid and extrusion of the polyglycolic acid, E and F into particles. The process may further comprise feeding the polyglycolic acid into an extruder, into which the E and the F are added.

The copolymer of the present invention may comprise a combination of E and F at about 0.01-5 wt %, preferably about 0.01-3 wt %, more preferably about 0.01-1 wt %, based on the total weight of the copolymer.

The polyglycolic acid or the polyglycolic acid copolymer may have a weight-average molecular weight of 10,000-1,000,000. The polyglycolic acid or the polyglycolic acid copolymer may have a ratio of a weight-average molecular weight to a number-average molecular weight (Mw/Mn) at about 10-4.0, preferably 1.1-3.0, more preferably 1.2-2.5.

The copolymer may have a melt index (MFR) of about 0.1-1000 g/10 min, preferably about 0.15-500 g/10 min, more preferably about 0.2-100 g/10 min. The MFR of a copolymer may be determined using a MFR method. The MFR method comprises drying the copolymer under vacuum at about 100-110° C. (e.g., about 105° C.); packing the dried copolymer into a rod; keeping the rod at a temperature of about 220-240° C. (e.g., about 230° C.), for about 0.5-1.5 minutes (e.g., about 1.0 minute); cutting a segment from the rod about every 15-45 seconds (e.g., about every 30 seconds); and determining a MFR of each segment based on MFR=600 W/t(g/10 min). W is the average mass of each segment. t is the cutting time gap for each segment. About 3-5 g (e.g., 4 g) of the dried copolymer may be loaded into a barrel, a plunger may be inserted into the barrel to compact the dried copolymer into the rod, and a weight of 2-3 kg (e.g., 2.16 kg) may be placed on the top of the plunger.

A thermoplastic polymer is determined in the following test: 1) drying a polymer in a vacuum drying oven at 105° C.; 2) reheating a test instrument to 230° C.; 3) loading 4 g of the dried polymer sample into a barrel through a funnel and inserting a piston into the barrel to compact the dried polymer sample in the barrel; 4) maintaining the compacted dried polymer sample in the barrel at 230° C. for 1 min, 5) placing a weight of 2.16 kg on top of the piston to press the sample through barrel, 6) cutting a segment of the pressed sample every 30 s to obtain a total of five segments; and 7) weighing the mass of each segment to calculate the MFR of the polymer as 600 times of the average mass of the segments per 10 minutes (i.e., MFR=600 W/t (g/10 min), where W is the average mass per segment of the polymer and t is the cutting time gap).

The polyglycolic acid or the polyglycolic acid copolymer in the composition may be prepared by a process comprising extruding the polyglycolic acid copolymer and the filler into particles. The particles may comprise 0.1-80 wt %, preferably 0.1-50 wt %, more preferably 0.1-30 wt %, of the filler, based on the total weight of the particles. The polyglycolic acid or the polyglycolic acid copolymer in the composition may have a melt flow rate (MFR) of 0.1-1000 g/10 min, preferably 0.15-500 g/10 min, more preferably 0.2-100 g/10 min.

For each composition of the invention, a process for preparing the composition is provided. The composition comprises 20-99.9 wt % of a polyglycolic acid copolymer and 0.1-80 wt % of a filler, based on the total weight of the composition. The polyglycolic acid copolymer is prepared with a polyglycolic acid produced from methyl glycolate by polycondensation. The composition has a tensile modulus greater than 5,800 MPa. The process comprises extruding and granulating a polyglycolic acid copolymer with a filler. The polyglycolic acid copolymer comprises one or more repeating units of C-(Aₓ-B_{y})ₙ-D. A is

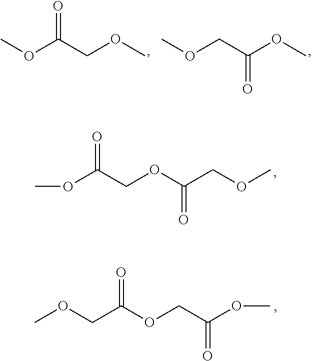

or a combination thereof; B is G-R₁—W; G and W are each selected from the group consisting of —CO—NH—, —CO—R₂—CO—OH, —CO—, —(CH₂)₂NH—CO—, —CH₂—CH(OH)—CH₂— and —NH; R₁ is an aliphatic polymer, an aromatic polymer or a combination thereof; R₂ is an alkyl group, an aromatic group, or an olefin group; x is between 1 and 1500; y is between 1 and 1500; n is between 1 and 10000; C and D are each a terminal group selected from the group consisting of a hydroxyl group, a carboxyl group, an amine group, an alkyl group, an aromatic group, an ether group, an alkene group, a halogenated hydrocarbon group and a combination thereof; and A and B are different in structure. As a result, the composition is prepared.

According to the process of the invention, the filler may be an inorganic filler selected from the group consisting of glass fiber, glass beads, talc, calcium carbonate, nano-clay, hydrotalcite, carbon black, carbon fiber, carbon nanotube, graphene, titanium dioxide, silicon dioxide, montmorillon Soil, steel fiber, hemp fiber, bamboo fiber, wood fiber, wood powder, wood chip, alumina, magnesia, zinc oxide, aluminum nitride, boron nitride, silicon carbide, graphite, silicon carbide, potassium titanate, aluminum borate, calcium sulfate, magnesium sulfate, ceramic whiskers, inorganic salt whiskers, metal whiskers and a combination thereof. The filler may be an organic filler is selected from the group consisting of cellulose whisker, poly(butyl acrylate-styrene), poly(4-hydroxybenzyl ester), polyethylene fiber, polyester fiber, aramid fiber, poly(p-phenylene benzobisoxazole)(PBO) fiber, polyamide fiber and a combination thereof.

The process may further comprise extruding and granulating the polyglycolic acid before extrusion and granulation of the polyglycolic acid with the filler.

The process may further comprise comprising extruding and granulating the polyglycolic acid with an additive before extrusion and granulation of the polyglycolic acid with the filler;

The additive may be selected from the group consisting of E, F or a combination thereof. E may be one or more of units of i-R₁-j; i and j are each selected from the group consisting of an isocyanate group (—N═C═O), an acid chloride group, an oxazolyl group, an oxazoline group, an anhydride, an epoxy group, an amine group and a combination thereof; R₁ is an aliphatic group, an aromatic group, or a combination thereof. F may be selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

A composition prepared according to the process of the invention.

The term “about” as used herein when referring to a measurable value such as an amount, a percentage, and the like, is meant to encompass variations of ±20% or ±10%, more preferably ±5%, even more preferably ±1%, and still more preferably ±0.1% from the specified value, as such variations are appropriate.

### EXAMPLE 1

### Polymer Production Process

1. Polyglycolide A

Polyglycolide A is prepared from glycolide by ring-opening polymerization.

Glycolide and ring-opening polymerization catalyst tin dichloride dihydrate in an amount of 0.01 part by weight relative to the weight of the glycolide are mixed uniformly in a prefabricated tank reactor at 120° C. for 60 min.

The material in the prefabricated tank reactor is then introduced into a polymerization reactor and reacted at 200° C. for 300 min under an absolute pressure of 0.1 MPa. The polymerization reactor is a plug flow reactor, which may be a static mixer, a twin-screw unit or a horizontal disk reaction.

The material in the polymerization reactor is then introduced into an optimization reactor at a mixing speed of 200 RPM at 220° C. and an absolute pressure of 50 Pa. The reaction time is 30 min. As a result, a polyglycolic acid is prepared.

2. Poly (glycolic acid) MG

Poly (glycolic acid) MG is prepared from glycolic acid by polycondensation.

Methyl glycolate and esterification catalyst stannous chloride dihydrate in an amount of 0.01 wt % relative to the weight of methyl glycolate are mixed in an esterification reactor at 30 rpm, 0.1 MPa (gauge pressure) and 180° C. for 90 min.

The materials in the esterification reactor are then transferred into a polycondensation reactor, and reacts with rare earth polycondensation catalyst in an amount of 5×10⁻⁵ parts relative to the weight of methyl glycolate at 80 rpm under an absolute pressure of 100 Pa and at 215° C. for 240 min.

The materials in the polycondensation reactor are then transferred into an optimized reactor and reacted at 225° C. for 45 min under an absolute pressure of 50 kPa.

### EXAMPLE 2

### Characterization

1. Weight-Average Molecular Weight and its Distribution

A sample is dissolved in a solution of five mmol/L sodium trifluoroacetate in hexafluoroisopropanol to prepare a solution of 0.05-0.3 wt % (mass fraction). The solution is then filtered with a 0.4 μm pore size polytetrafluoroethylene filter. 20 μL of the filtered solution is added to the Gel permeation chromatography (GPC) injector for determination of molecular weight of the sample. Five standard molecular weights of methyl methacrylate with different molecular weights are used for molecular weight correction.

2. Tensile Strength Test

The tensile strength is tested according to GB/T1040 1-2006 and the tensile speed is 50 mm/min.

3. Melt Flow Rate (MFR) Test

The melt flow rate (MFR), also known as the melt flow index (MFI), of a thermoplastic polymer is determined in the following test: 1) drying a polymer in a vacuum drying oven at 105° C.; 2) reheating a test instrument to 230° C.; 3) loading 4 g of the dried polymer sample into a barrel through a funnel and inserting a piston into the barrel to compact the dried polymer sample in the barrel; 4) maintaining the compacted dried polymer sample in the barrel at 230° C. for 1 min, 5) placing a weight of 2.16 kg on top of the piston to press the sample through barrel, 6) cutting a segment of the pressed sample every 30 s to obtain a total of five segments; and 7) weighing the mass of each segment to calculate the MFR of the polymer as 600 times of the average mass of the segments per 10 minutes (i.e., MFR=600 W/t (g/10 min), where W is the average mass per segment of the polymer and t is the cutting time gap).

### EXAMPLE 3

### PGA and PGA Copolymer Samples

Five samples, PGA 1, PGA 2, PGA 3, PGA Copolymer 1 and PGA Copolymer 2, were prepared with Polyglycolide A or Poly (glycolic acid) MG of Example 1 and one or more additives such as antioxidant Irganox 168, metal passivator Naugard XL-1 and/or structural modifier ADR4368. The Polyglycolide A or Poly(glycolic acid) MG along with the additives were placed in a twin-screw extruder and then extruded and granulated into particles at an extrusion temperature of 250° C. The particles were dried at 120° C. for 4 hours and molded into strips for testing using an injection-molding machine at an injection temperature of 250° C. and a molding temperature of 100° C. Table 1 shows the composition and testing results for each of these five samples.

TABLE 1
Polymer Synthesis Parameters and Performance Results

| | | | | PGA | PGA |
|---|---|---|---|---|---|
| Sample | PGA 1 | PGA 2 | PGA 3 | Copolymer 1 | Copolymer 2 |
| Polyglycolide A | 99.94 | | | 99.78 | |
| (wt %) | | | | | |
| Poly (glycolic acid) | | 99.94 | 99.88 | | 99.78 |
| MG (wt %) | | | | | |
| Irganox 168 | 0.06 | 0.06 | 0.06 | 0.06 | 0.06 |
| (wt %) | | | | | |
| Naugard XL-1 | | | 0.06 | 0.06 | 0.06 |
| (wt %) | | | | | |
| ADR4368 | | | | 0.1 | 0.1 |
| (wt %) | | | | | |
| MFR | 37 | 27 | 19 | 10 | 5 |
| (g/10 min) | | | | | |
| Mw | 118100 | 147600 | 163200 | 170000 | 179000 |
| (g/mol) | | | | | |

In general, polyglycolic acid degrades even after being processed by extrusion. The MFR of particles after granulation by extrusion reflects the melting thermal stability of the polymer. The higher the MFR of the particles is after granulation, the worse the melting thermal stability of the polymer is. Based on the comparison to PGA 1, the use of Poly (glycolic acid) MG, which has higher purity, and/or the addition of metal passivator Naugard XL-1 or structural modifier ADR4368 in latter samples, lowered the MFR value, indicating improvement of the melting thermal stability.

### EXAMPLE 4

### PGA or PGA Copolymer Compositions

15 compositions comprising different amounts of the PGA or PGA copolymers of Example 3 with different amounts of inorganic fillers such as glass fiber, carbon fiber and aramid fiber (TWARON fiber). These ingredients were placed in a twin-screw extruder and then extruded for granulation into particles at an extrusion temperature of 250° C. The particles were dried at 120° C. for 4 hours and molded into stripes for testing using an injection-molding machine at an injection temperature of 250° C. and a molding temperature of 100° C. Table 2 shows the composition and the testing results of these compositions.

In general, it is inevitable that polyglycolic acid has some degradation during a second extrusion. The MFR of Compositions 1-5 increased after being processed by an extruder.

Based on the comparison between Compositions 1 and 2 and between Compositions 4 and 5, the melting thermal stability of the polyglycolic acid or polyglycolic acid copolymer compositions produced by the new process was slightly improved. Based on the comparison of Compositions 3 and 4 with Composition 2, a copolymer produced with a metal passivator and ADR4368 showed higher melting thermal stability.

As shown in Compositions 6-9, PGA copolymer compositions with 30 wt % of glass fiber have better melting thermal stability and mechanical properties than PGA compositions. After adding a metal deactivator to a PGA copolymer prepared from the poly (glycolic acid) by the new process, the PGA copolymer with 30 wt % glass fiber showed the best melting thermal stability and mechanical properties. So do compositions with 10wt % of glass fibers in Composition 10 and 11.

Similarly, as shown in Compositions 12-15, besides glass fibers, PGA compositions with carbon fibers or Twaron fibers still have better melting thermal stability and mechanical properties if using the poly (glycolic acid) from the new process.

The addition of an inorganic filler caused degradation of polyglycolic acid. Based on the comparison between Compositions 2 and 5 , and Compositions 7 and 9, PGA or PGA copolymer composition with Naugard XL-1 and ADR4368 have lower MFR, indicating improved melting thermal stability of the material and reduced degradation. Also the significant increased tensile modulus at 23° C. and 150° C. indicates that, the process for preparing the PGA copolymer is essential for increasing the melting thermal stability and mechanical properties.

TABLE 2
Composition compositions and testing Results

| Composition | 1 | 2 | 3 | 4 | 5 | 6 | 7 | 8 |
|---|---|---|---|---|---|---|---|---|
| PGA 1 (wt %) | 100 | | | | | 70 | | |
| PGA 2 (wt %) | | 100 | | | | | 70 | |
| PGA 3 (wt %) | | | 100 | | | | | |
| PGA Copolymer 1 (wt %) | | | | 100 | | | | 70 |
| PGA Copolymer 2 (wt %) | | | | | 100 | | | |
| Glass fiber (wt %) | | | | | | 30 | 30 | 30 |
| Carbon fiber (wt %) | | | | | | | | |
| Twaron fiber (wt %) | | | | | | | | |
| MFR (g/10 min) | 97 | 87 | 79 | 70 | 65 | 85 | 82 | 40 |
| Tensile modulus @ 23° C. (MPa) | 5988 | 6021 | 6032 | 6077 | 6081 | 8520 | 8610 | 8797 |
| Tensile stress @ 23° C. (MPa) | 114 | 114 | 115 | 113 | 116 | 150 | 152 | 158 |
| Tensile elongation @ 23° C. (MPa) | 10.1 | 12 | 11 | 16 | 15 | 3 | 3.3 | 3.2 |
| Tensile modulus @ 150° C. (MPa) | 479 | 489 | 491 | 510 | 517 | 4170 | 4190 | 4499 |
| Tensile stress @ 150° C. (MPa) | 24 | 25 | 25 | 24 | 27 | 69 | 70 | 74 |
| Tensile elongation @ 150° C. (MPa) | Unbroken | Unbroken | Unbroken | Unbroken | Unbroken | 3.7 | 3.8 | 4.1 |

| Composition | 9 | 10 | 11 | 12 | 13 | 14 | 15 |
|---|---|---|---|---|---|---|---|
| PGA 1 (wt %) | | | | | | | |
| PGA 2 (wt %) | | | | | | | |
| PGA 3 (wt %) | | | | | | | |
| PGA Copolymer 1 (wt %) | | 90 | | 75 | | 90 | |
| PGA Copolymer 2 (wt %) | 70 | | 90 | | 75 | | 90 |
| Glass fiber (wt %) | 30 | 10 | 10 | | | | |
| Carbon fiber (wt %) | | | | 25 | 25 | | |
| Twaron fiber (wt %) | | | | | | 10 | 10 |
| MFR (g/10 min) | 30 | 57 | 50 | 53 | 42 | 57 | 52 |
| Tensile modulus @ 23° C. (MPa) | 9032 | 6751 | 7093 | 12105 | 12404 | 6751 | 7012 |
| Tensile stress @ 23° C. (MPa) | 162 | 128 | 139 | 204 | 219 | 128 | 135 |
| Tensile elongation @ 23° C. (MPa) | 3.3 | 11.1 | 17 | 2.9 | 2.7 | 11.1 | 15.3 |
| Tensile modulus @ 150° C. (MPa) | 4639 | 3397 | 3582 | 6553 | 6799 | 3397 | 3599 |
| Tensile stress @ 150° C. (MPa) | 79 | 65 | 69 | 79 | 82 | 65 | 69 |
| Tensile elongation @ 150° C. (MPa) | 4.4 | 35 | 32 | 2 | 2.2 | 35 | 39 |

1. A composition comprising 20-99.9 wt % of a polyglycolic acid copolymer and 0.1-80 wt % of a filler, based on the total weight of the composition, wherein the composition has a tensile modulus greater than 5,800 MPa, wherein the polyglycolic acid copolymer comprises one or more repeating units of C-(Aₓ-B_{y})ₙ-D, wherein:
A is or a combination 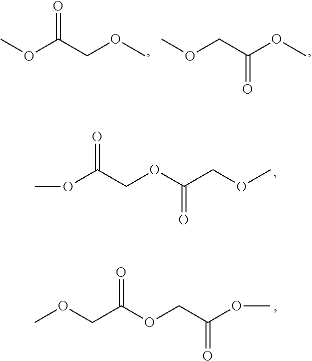
thereof;
B is G-R₁—W;
G and W are each selected from the group consisting of —CO—NH—, −CO—R₂—CO—OH, —CO—, —(CH₂)₂NH—CO—, —CH₂—CH(OH)—CH₂— and —NH;
R₁ is an aliphatic polymer, an aromatic polymer or a combination thereof;
R₂ is an alkyl group, an aromatic group, or an olefin group;
x is between 1 and 1500;
y is between 1 and 1500;
n is between 1 and 10000;
C and D are each a terminal group selected from the group consisting of a hydroxyl group, a carboxyl group, an amine group, an alkyl group, an aromatic group, an ether group, an alkene group, a halogenated hydrocarbon group and a combination thereof;
A and B are different in structure; and
wherein the polyglycolic acid copolymer is prepared with a polyglycolic acid produced from methyl glycolate by polycondensation.

2. The composition of claim 1, wherein the filler is an inorganic filler selected from the group consisting of glass fiber, glass beads, talc, calcium carbonate, nano-clay, hydrotalcite, carbon black, carbon fiber, carbon nanotube, graphene, titanium dioxide, silicon dioxide, montmorillon Soil, steel fiber, hemp fiber, bamboo fiber, wood fiber, wood powder, wood chip, alumina, magnesia, zinc oxide, aluminum nitride, boron nitride, silicon carbide, graphite, silicon carbide, potassium titanate, aluminum borate, calcium sulfate, magnesium sulfate, ceramic whiskers, inorganic salt whiskers, metal whiskers and a combination thereof.

3. The composition of claim 1, wherein the filler is an organic filler is selected from the group consisting of cellulose whisker, poly(butyl acrylate-styrene), poly(4-hydroxybenzyl ester), polyethylene fiber, polyester fiber, aramid fiber, poly(p-phenylene benzobisoxazole)(PBO) fiber, polyamide fiber and a combination thereof.

4. The composition of claim 1, further comprising an additive selected from the group consisting of E and F,
wherein E is one or more of units of i-R₁-j; i and j are each selected from the group consisting of an isocyanate group (—N═C═O), an acid chloride group, an oxazolyl group, an oxazoline group, an anhydride, an epoxy group, an amine group and a combination thereof; R₁ is an aliphatic group, an aromatic group, or a combination thereof; and
wherein F is selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

5. The composition of claim 1, wherein the polyglycolic acid copolymer has a weight-average molecular weight of 10,000-1,000,000.

6. The composition of claim 1, wherein the polyglycolic acid copolymer has a ratio of a weight-average molecular weight to a number-average molecular weight (Mw/Mn) of 1.0-4.0.

7. The composition of claim 1, wherein the polyglycolic acid copolymer has a melt flow rate (MFR) of 0.1-1000 g/10 min.

8. A process for preparing a composition, wherein the composition comprises 20-99.9 wt % of a polyglycolic acid or a polyglycolic acid copolymer and 0.1-80 wt % of a filler, based on the total weight of the composition, wherein the polyglycolic acid copolymer is prepared with a polyglycolic acid produced from methyl glycolate by polycondensation, wherein the composition has a tensile modulus greater than 5,800 MPa, the process comprising extruding and granulating a polyglycolic acid copolymer with a filler, wherein the polyglycolic acid copolymer comprises one or more repeating units of C-(Aₓ-B_{y})ₙ-D, wherein:
A is or a combination 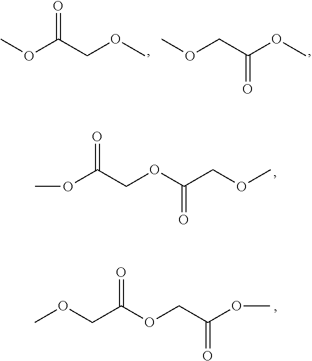
thereof;
B is G-R₁—W;
G and W are each selected from the group consisting of —CO—NH—, —CO—R₂—CO—OH, —CO—, —(CH₂)₂NH—CO—, —CH₂—CH(OH)—CH₂— and —NH;
R₁ is an aliphatic polymer, an aromatic polymer or a combination thereof;
R₂ is an alkyl group, an aromatic group, or an olefin group;
x is between 1 and 1500;
y is between 1 and 1500;
n is between 1 and 10000;
C and D are each a terminal group selected from the group consisting of a hydroxyl group, a carboxyl group, an amine group, an alkyl group, an aromatic group, an ether group, an alkene group, a halogenated hydrocarbon group and a combination thereof; and
A and B are different in structure;
whereby the composition is prepared.

9. The process of claim 8, wherein the filler is an inorganic filler selected from the group consisting of glass fiber, glass beads, talc, calcium carbonate, nano-clay, hydrotalcite, carbon black, carbon fiber, carbon nanotube, graphene, titanium dioxide, silicon dioxide, montmorillon Soil, steel fiber, hemp fiber, bamboo fiber, wood fiber, wood powder, wood chip, alumina, magnesia, zinc oxide, aluminum nitride, boron nitride, silicon carbide, graphite, silicon carbide, potassium titanate, aluminum borate, calcium sulfate, magnesium sulfate, ceramic whiskers, inorganic salt whiskers, metal whiskers and a combination thereof.

10. The process of claim 8, wherein the filler is an organic filler is selected from the group consisting of cellulose whisker, poly(butyl acrylate-styrene), poly(4-hydroxybenzyl ester), polyethylene fiber, polyester fiber, aramid fiber, poly(p-phenylene benzobisoxazole)(PBO) fiber, polyamide fiber and a combination thereof.

11. The process of claim 8, further comprising extruding and granulating the polyglycolic acid before extrusion and granulation of the polyglycolic acid with the filler.

12. The process of claim 8, further comprising extruding and granulating the polyglycolic acid with an additive before extrusion and granulation of the polyglycolic acid with the filler;
wherein the additive is selected from the group consisting of E, F or a combination thereof;
wherein E is one or more of units of i and j are each selected from the group consisting of an isocyanate group (—N═C═O), an acid chloride group, an oxazolyl group, an oxazoline group, an anhydride, an epoxy group, an amine group and a combination thereof;
R₁ is an aliphatic group, an aromatic group, or a combination thereof; and
wherein F is selected from the group consisting of an antioxidant, a metal passivator, an end capping agent, a nucleating agent, an acid scavenger, a heat stabilizer, a UV stabilizer, a lubricant plasticizer, a crosslinking agent, and a combination thereof.

13. The process of claim 8, further comprising polycondensation of methyl glycolate to form the polyglycolic acid.

14. A composition prepared according to the process of claim 8.
